(19) United States
(12) Patent Application Publication
(10) Pub. No.: US 2026/0287892 A1
(43) Pub. Date: Sep. 24, 2026

(54) INFORMATION PROCESSING APPARATUS, HEAD MOUNTED DISPLAY, CONTROL METHOD FOR INFORMATION PROCESSING APPARATUS, AND STORAGE MEDIUM THAT ENABLES A USER TO VIEW IMAGES IN APPROPRIATE VISUAL RECOGNITION STATE THROUGH LEFT AND RIGHT DISPLAY UNITS RESPECTIVELY HELD IN FRONT OF BOTH EYES OF THE USER

(71) Applicant: CANON KABUSHIKI KAISHA, Tokyo (JP)

(72) Inventor: KEITA KONDO, Tokyo (JP)

(21) Appl. No.: 19/569,463

(22) Filed: Mar. 17, 2026

(30) Foreign Application Priority Data
Mar. 21, 2025 (JP) 2025-046544

(51) Int. Cl. G02B 27/01; G06F 3/01; G06T 19/00; G06T 19/20

(52) U.S. Cl. CPC G02B 27/017; G06F 3/013; G06T 19/006; G06T 19/20; G06T 2219/2012

(57) ABSTRACT

A mechanism that enables a user to view images in an appropriate visual recognition state through left and right display units is provided. An information processing apparatus includes one or more processors and memory configured to execute a display processing that performs a display of an indicator image in an image that a user can view through left and right display units whose positions are capable of being adjusted separately at least in front-back and left-right directions when respectively held in front of both eyes of the user. In the display processing, the display of the indicator image is performed as a display indicating an edge of a theoretical viewing area in which the user can theoretically view the image through the left and right display units in a case where the positions of the left and right display units respectively become positions correct for both eyes of the user.

### BACKGROUND

### Field of the Technology

The present disclosure relates to an information processing apparatus, a head mounted display, a control method for the information processing apparatus, and a storage medium.

### Description of the Related Art

Conventionally, a head mounted display (hereinafter, referred to as “an HMD”) has been known as a head mounted image display device that displays images to both eyes of a user. In addition, as HMDs have become more widespread in recent years, they are increasingly being used in events held in museums, exhibitions, and the like. In many such cases, it is thought that an unspecified number of users will take turns wearing an HMD and view a content using XR or the like. It should be noted that the XR refers to a technology that realizes the fusion of the real world and a virtual world, and the XR is a general term for virtual reality (VR), augmented reality (AR), mixed reality (MR), substitutional reality (SR), and the like.

However, in the case where an unspecified number of users take turns wearing an HMD, since the interpupillary distance, the head shape, and the like for each user are different, there is no wearing position of the HMD, which is common to everyone, and it is necessary to adjust the wearing position of the HMD for each user. Therefore, in order to achieve smooth and appropriate viewing, it is desirable to perform a quick position adjustment so that the wearing position of the HMD becomes a position correct for both eyes of the user.

As related techniques, for example, there are a technique disclosed in Japanese Patent No. 6873599 and a technique disclosed in Japanese Laid-Open Patent Publication (kokai) No. H9-304729. In the technique disclosed in Japanese Patent No. 6873599, when left and right display units of an HMD are misaligned in the depth direction, a test pattern that appears blurred to the user is displayed on images of the left and right display units, thereby making the user aware of the misalignment of the wearing position of the HMD. In addition, in the technique disclosed in Japanese Laid-Open Patent Publication (kokai) No. H9-304729, by displaying images that are different from each other on left and right display units of an HMD, the user is prompted to adjust the wearing position of the HMD until positioning data included in these images appears as a predetermined shape to both eyes of the user.

However, in the technique disclosed in Japanese Patent No. 6873599 and the technique disclosed in Japanese Laid-Open Patent Publication (kokai) No. H9-304729, it is necessary to adjust the left and right display units simultaneously. In this regard, for example, in the case where the user uses the HMD for the first time, since the user does not know the correct appearance on the left and right display units and the adjustment method of the left and right display units, it may be difficult for the user to adjust the left and right display units simultaneously. Thus, if the user is not able to adjust the wearing position of the HMD to the position correct for both eyes of the user, there will be an issue in that the user will view the images on the left and right display units in an inappropriate visual recognition state such as a blurred state, a misaligned-in-size state, or a state in which distortion occurs near the edges of the display.

### SUMMARY

The present disclosure provides a mechanism that enables a user to view images in an appropriate visual recognition state through left and right display units respectively held in front of both eyes of the user.

Accordingly, a first aspect of the present disclosure provides an information processing apparatus comprising one or more processors and memory configured to execute a display processing that performs a display of an indicator image in an image that a user is able to view through left and right display units whose positions are capable of being adjusted separately at least in a front-back direction and a left-right direction when respectively held in front of both eyes of the user. In the display processing, the display of the indicator image is performed as a display indicating an edge of a theoretical viewing area in which the user is able to theoretically view the image through the left and right display units in a case where the positions of the left and right display units respectively become positions correct for both eyes of the user.

Accordingly, a second aspect of the present disclosure provides a head mounted display comprising the information processing apparatus, the left and right display units, and a holding portion for holding the left and right display units on the user's head or in the user's hand.

Features of the present disclosure will become apparent from the following description of embodiments with reference to the attached drawings. The following description of embodiments is described by way of example.

### BRIEF DESCRIPTION OF THE DRAWINGS

FIG. 1A is an exterior perspective view of an HMD 100 and an information processing apparatus 110, and FIG. 1B is an exterior perspective view of a display main body 101 of the HMD 100.

FIGS. 2A and 2B are schematic block diagrams of an image display system configured with the HMD 100 and the information processing apparatus 110.

FIG. 3 is a sectional view that schematically illustrates a configuration of a display unit 103 of the display main body 101.

FIGS. 4A, 4B, and 4C are views that illustrate changes in the position of the display unit 103 of the display main body 101.

FIGS. 5A, 5B, and 5C, are views that illustrate the state when the display main body 101 is held on the head of a user by a holding portion 104.

FIGS. 6A, 6B, 6C, and 6D are views that illustrate MR images displayed on a display panel 301, which is one of the internal components of the display unit 103 of the display main body 101 in a first embodiment.

FIGS. 7A, 7B, 7C, and 7D are views that illustrate MR images when the user views the display panel 301 through a display unit 103L of the display main body 101 according to one or more aspects of the present disclosure.

FIG. 8 is a flowchart that illustrates the operation of the information processing apparatus 110 when controlling the display and non-display of an indicator image.

FIGS. 9A, 9B, and 9C are views that illustrate how the display panel 301 appears when the user views the display panel 301 through the display unit 103L of the display main body 101 according to one or more aspects of the present disclosure.

FIGS. 10A, 10B, and 10C are views that illustrate how the display panel 301 appears when the user views the display panel 301 through the display unit 103L of the display main body 101 according to one or more aspects of the present disclosure.

FIG. 11 is a view that illustrates how the display panel 301 appears when the user views the display panel 301 through the display unit 103L of the display main body 101 according to one or more aspects of the present disclosure.

FIG. 12 is a view that illustrates a configuration for sight line detection between the display main body 101 and the information processing apparatus 110.

### DESCRIPTION OF THE EMBODIMENTS

The present disclosure will now be described in detail below with reference to the accompanying drawings showing embodiments thereof.

Hereinafter, each embodiment of the present disclosure will be described in detail with reference to the drawings. However, the configuration described in each embodiment below is merely an example, and the scope of the present disclosure is not limited by the configuration described in each embodiment. For example, each unit (each component) constituting the present disclosure can be replaced with a unit (a component) with any configuration that can perform the same function(s). In addition, any component(s) may be added. Furthermore, any two or more configurations (features) of each embodiment can be combined. It should be noted that in each drawing, the same components are denoted by the same reference numerals, and the description thereof may be omitted.

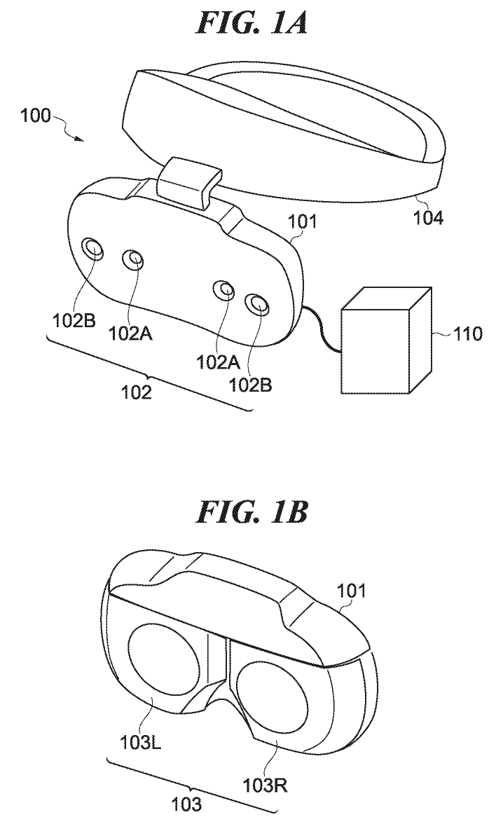

Hereinafter, a first embodiment of the present disclosure will be described with reference to FIGS. 1A to 8. FIG. 1A is an exterior perspective view of an HMD 100 and an information processing apparatus 110 as viewed from the subject side. As shown in FIG. 1A, the HMD 100 includes a display main body 101. The display main body 101 is a main body that is capable of providing a user with an XR experience such as a VR experience, an AR experience, an MR experience, or an SR experience. FIG. 1B is an exterior perspective view of the display main body 101 as viewed from the user side. As shown in FIGS. 1A and 1B, the display main body 101 includes an image pickup unit 102 and a display unit 103. The display unit 103 includes a display unit 103R and a display unit 103L. The display unit 103R is located in front of the right eye of the user wearing the HMD 100. The display unit 103L is located in front of the left eye of the user wearing the HMD 100. It should be noted that in the following description, in the case where the display unit 103R and the display unit 103L are collectively referred to, they will be referred to as “the display unit 103” or “left and right display units 103”.

As shown in FIG. 1A, the image pickup unit 102 includes two background image cameras 102A and two attitude detection cameras 102B. The two background image cameras 102A are arranged on the front surface of the display main body 101 one on the left side and one on the right side, and the two attitude detection cameras 102B are arranged on the front surface of the display main body 101 one on the left side and one on the right side. The two background image cameras 102A play a role of eyes in a video see-through image. The background image cameras 102A obtain (capture) a real space image that serves as the basis for a background image (that is, the portion that is not a computer graphics image (a CG image)). In order to perform the alignment of the CG image and the background image that the user views through the display unit 103, the attitude detection cameras 102B obtain position and attitude data of the display main body 101. Therefore, the HMD 100 is a video see-through type HMD, but is not limited to a video see-through type HMD, and may be an optical see-through type HMD or a fully immersive type HMD.

As shown in FIG. 1A, the display main body 101 is provided with a holding portion 104. The holding portion 104 is attached to the head of the user in a way of wearing a headband, thereby respectively holding the left and right display units 103 (of the display main body 101) in front of both eyes of the user. In this way, the HMD 100 is worn on the head of the user. It should be noted that the form of the holding portion 104 is not limited to the above headband-shaped form as long as it is capable of respectively holding the left and right display units 103 (of the display main body 101) in front of both eyes of the user. Other forms of the holding portion 104 may include, for example, a helmet-type form that covers the entire upper part of the head of the user, a glasses-type form that is hung on ears of the user, a form configured with a handheld portion that the user holds, and a form configured with an attachment portion that is attached to one of hands (including arms) of the user.

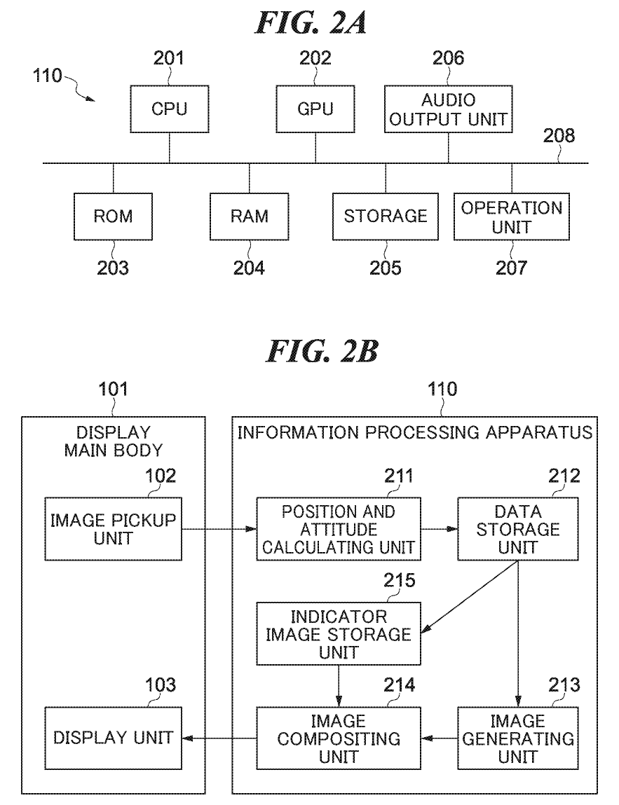

In addition, the information processing apparatus 110 is connected to the display main body 101 so as to be capable of performing data communication with the display main body 101. In FIG. 1A, the display main body 101 and the information processing apparatus 110 are connected to each other by wire, but they may be connected to each other wirelessly. It should be noted that as shown in FIGS. 2A and 2B, which will be described below, the information processing apparatus 110, together with the HMD 100, constitutes an image display system.

The information processing apparatus 110 is a small-sized box type computer that is capable of being worn over the shoulder by the user, but is not limited to a small-sized box type computer. The information processing apparatus 110 may be, for example, a laptop personal computer (a laptop PC), a mobile terminal such as a smartphone or a tablet, or a desktop personal computer (a desktop PC). In addition, although the information processing apparatus 110 and the HMD 100 are configured as separate devices, the present disclosure is not limited to this configuration, and the information processing apparatus 110 and the HMD 100 may be configured integrally by incorporating the information processing apparatus 110 into the HMD 100.

FIGS. 2A and 2B are schematic block diagrams of the image display system configured with the HMD 100 and the information processing apparatus 110. More specifically, the image display system is configured with the display main body 101 of the HMD 100, and the information processing apparatus 110. FIG. 2A is a schematic block diagram that illustrates a hardware configuration of the information processing apparatus 110. As shown in FIG. 2A, the information processing apparatus 110 has the hardware configuration, which includes a central processing unit (CPU) 201, a graphics processing unit (GPU) 202, a read only memory (ROM) 203, a random-access memory (RAM) 204, a storage 205, an audio output unit 206, an operation unit 207, etc. The CPU 201, the GPU 202, the ROM 203, the RAM 204, the storage 205, the audio output unit 206, the operation unit 207, etc., are communicably connected to each other via a system bus 208.

The CPU 201 performs the control of each unit (each component) connected to the system bus 208. The CPU 201 executes programs stored in the ROM 203, the storage 205, and the like to implement, for example, the processing of each functional configuration and a flowchart, which will be described below. The GPU 202 is controlled by the CPU 201 and programs, and executes image processing. The ROM 203 has a storage area in which the programs executed by the CPU 201 and the like are stored. The RAM 204 has a storage area that functions as a working area when the CPU 201 loads and executes the program. The storage 205 has a storage area in which various kinds of data including various kinds of programs and data, etc., which are required when the CPU 201 executes processing, are stored. The storage 205 is, for example, a hard disk drive (HDD), a solid state drive (SSD), or the like.

The audio output unit 206 is a speaker that outputs audio of a content using the XR or the like, audio of instructions to the user, and the like. It should be noted that the audio output unit 206 may be a headphone or an earphone connected to the information processing apparatus 110 by wire or wirelessly, or may be provided in the display main body 101 of the HMD 100. The operation unit 207 includes buttons to be pressed by the user, that is, includes a “YES” button and a “NO” button. It should be noted that the operation unit 207 may be provided on the display main body 101 of the HMD 100. In addition, the operation unit 207 may include a character information input device such as a keyboard, a pointing device such as a mouse, a dial, a joystick, etc., in addition to the above buttons, or may be a controller separate from the information processing apparatus 110.

FIG. 2B is a schematic block diagram of the display main body 101 and the information processing apparatus 110. As described above, the display main body 101 includes the image pickup unit 102 and the display unit 103. The information processing apparatus 110 includes a position and attitude calculating unit 211, a data storage unit 212, an image generating unit 213, an image compositing unit 214, and an indicator image storage unit 215. The real space image and the position and attitude data are imported to the information processing apparatus 110 from the image pickup unit 102 of the display main body 101. In the information processing apparatus 110, based on the real space image and the position and attitude data that have been imported, a background image and a CG image, which have been generated by the image generating unit 213 via the position and attitude calculating unit 211 and the data storage unit 212, are composited by the image compositing unit 214.

In the first embodiment, this composited image is output as an MR image to the display unit 103 of the display main body 101. Furthermore, in the information processing apparatus 110, an indicator image output from the indicator image storage unit 215 is also capable of being composited with the MR image by the image compositing unit 214. In addition, the image compositing unit 214 is also capable of being configured not to composite the indicator image with the MR image in response to an input from the operation unit 207. It should be noted that the indicator image will be described in detail below. In addition, as described above, the display unit 103 of the display main body 101 is configured to display the MR image, but the present disclosure is not limited to this configuration. For example, the display unit 103 of the display main body 101 may be configured to display an XR image other than the MR image (that is, an AR image, a VR image, or an SR image), or an image other than the XR image.

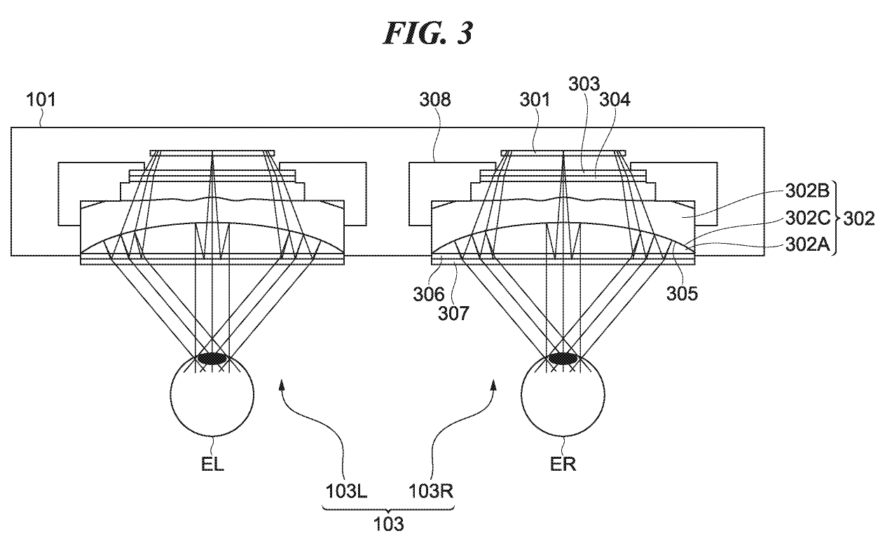

FIG. 3 is a sectional view that schematically illustrates a configuration of the display unit 103 of the display main body 101. In FIG. 3, the display of internal parts (internal components) of the display main body 101 that are not necessary for describing the configuration of the display unit 103 is omitted. In addition, in the following, the display unit 103R located in front of the right eye ER of the user wearing the HMD 100 will be described, but the display unit 103L located in front of the left eye EL of the user wearing the HMD 100 is also capable of being described in a similar manner. Therefore, the description of the display unit 103L will be omitted. It should be noted that in the following description, in the case where the right eye ER and the left eye EL are collectively referred to, they will be referred to as “both eyes”.

The display unit 103R includes an optical system that folds an optical path using polarized light. The optical system and the optical path of the display unit 103R will now be described. The display unit 103R enlarges and projects an original image displayed on a display panel 301 as a virtual image and guides it to the right eye ER of the user. A cemented lens 302 includes a lens 302A, a lens 302B, and an adhesive 302C. The lens 302A and the lens 302B are cemented together by the adhesive 302C. Between the display panel 301 and the lens 302B, a polarizing plate 303 and a first phase plate 304 are arranged in this order from the display panel 301 side. In addition, a half mirror 305 is vapor-deposited on the surface of the lens 302B facing the lens 302A. The surface on which the half mirror 305 is vapor-deposited acts as a semi-transparent reflecting surface.

On the other hand, between the lens 302A and the right eye ER of the user, a second phase plate 306 and a polarizing beam splitter (PBS) 307, which is a polarization separation element, are arranged in this order from the lens 302A side. The second phase plate 306 and the PBS 307 have a planar shape. The first phase plate 304 and the second phase plate 306 are wave plates with a phase difference of λ/4. The second phase plate 306 is held in contact with the lens 302A. Furthermore, a lens barrel 308 holds the polarizing plate 303, the first phase plate 304, and the lens 302B. In the display unit 103R, a polarization direction of light passing through the polarizing plate 303 is tilted at 45° from a slow axis of the first phase plate 304. In addition, a polarization direction of light passing through the PBS 307 is tilted at 45° from a slow axis of the second phase plate 306. Furthermore, the polarization direction of the light passing through the polarizing plate 303 and the polarization direction of the light passing through the PBS 307 are perpendicular to each other.

In such an optical system, light emitted from the display panel 301 (hereinafter, referred to as “emitted light”) passes through the polarizing plate 303 to become linearly polarized light, and passes through the first phase plate 304 to become circularly polarized light. Furthermore, the emitted light passes through the half mirror 305 and the second phase plate 306 to become linearly polarized light (first linearly polarized light). However, a polarization direction of this linearly polarized light (the first linearly polarized light) is perpendicular to a polarization direction that is capable of being transmitted through the PBS 307. Therefore, the emitted light is reflected by the PBS 307 and then passes through the second phase plate 306 to become circularly polarized light.

Furthermore, the emitted light is reflected by the half mirror 305 and then passes through the second phase plate 306 to become linearly polarized light (second linearly polarized light). However, a polarization direction of this linearly polarized light (the second linearly polarized light) is different from that of the first linearly polarized light, and coincides with the polarization direction that is capable of being transmitted through the PBS 307. Therefore, the emitted light passes through the PBS 307 and is guided to the right eye ER of the user. It should be noted that the right eye ER of the user substantially coincides with the exit pupil of the display unit 103R. In this way, the display unit 103R includes the optical system that folds the optical path using the polarized light, thereby making it possible to make the display unit 103R thin and shorten the focal length, and furthermore, to realize image observation with a wide angle of view.

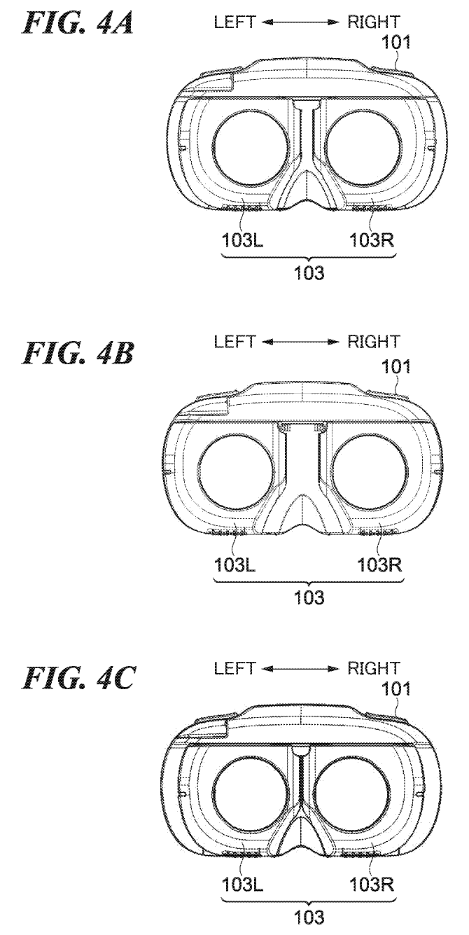

FIGS. 4A, 4B, and 4C are views that illustrate changes in the position of the display unit 103 of the display main body 101. The display unit 103L and the display unit 103R, which constitute the display unit 103, are configured to be separately movable in a left-right direction on the display main body 101. For example, in FIG. 4A, the display unit 103L and the display unit 103R are adjusted to the center position in the left-right direction (that is, the interpupillary distance direction) to which the display unit 103L and the display unit 103R are capable of being moved. In addition, in FIG. 4B, the display unit 103L and the display unit 103R are adjusted to positions that correspond to a user with a wider interpupillary distance, and in FIG. 4C, the display unit 103L and the display unit 103R are adjusted to positions that correspond to a user with a narrower interpupillary distance. In this way, even in the case where one user of users with different interpupillary distances views the MR image with the display main body 101, the one user is able to respectively move the display unit 103L and the display unit 103R in front of both eyes of the one user by moving the display unit 103L and the display unit 103R in the left-right direction separately.

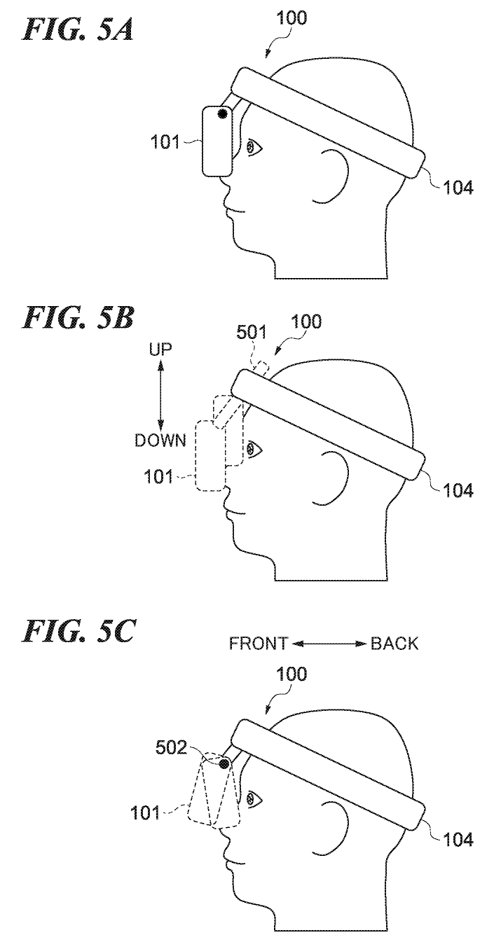

FIGS. 5A, 5B, and 5C are views that illustrate the state when the display main body 101 is held on the head of the user by the holding portion 104. FIG. 5A is a view that illustrates a state in which the left and right display units 103 (of the display main body 101) are respectively located in front of both eyes of the user. The user who is in the state shown in FIG. 5A is able to view the MR image.

FIG. 5B is a view that illustrates a state when the display main body 101 is moved in an up-down direction relative to the holding portion 104. It should be noted that the up-down direction refers to a direction in which the forehead of the user is located upward and the side where the chin of the user is located downward. Depending on the shape of the head of the user (the head shape of the user), the position, at which the holding portion 104 is attached to the head of the user, differs in the up-down direction. For this reason, depending on the position at which the holding portion 104 is attached, the positions of the left and right display units 103 (of the display main body 101) may also respectively move in the up-down direction. Therefore, in order to address this issue, an up-down position adjustment mechanism 501 is provided between the display main body 101 and the holding portion 104, which is capable of adjusting the position of the display main body 101 in the up-down direction. It should be noted that the up-down position adjustment mechanism 501 is realized by, for example, a rack and pinion mechanism. In addition, the up-down position adjustment mechanism 501 may be configured to be capable of separately adjusting the positions of the left and right display units 103 (of the display main body 101) in the up-down direction.

FIG. 5C is a view that illustrates a state when the display main body 101 is moved in a front-back direction relative to the holding portion 104. It should be noted that the front-back direction refers to a direction in which the side farther from the face of the user is in the front and the side closer to the face of the user is at the back. Depending on the head shape of the user, the position, at which the holding portion 104 is attached to the head of the user, differs in the front-back direction. For this reason, depending on the position at which the holding portion 104 is attached, the positions of the left and right display units 103 (of the display main body 101) may also respectively move in the front-back direction (that is, an eye relief direction). Therefore, in order to address this issue, a front-back position adjustment mechanism 502 is provided between the display main body 101 and the holding portion 104, which is capable of adjusting the position of the display main body 101 in the front-back direction.

It should be noted that in FIG. 5C, a hinged pivotal front-back position adjustment mechanism 502 is provided between the display main body 101 and the holding portion 104, but a linear front-back position adjustment mechanism configured with, for example, a rack and pinion mechanism may be provided between the display main body 101 and the holding portion 104. In addition, the front-back position adjustment mechanism 502 may be configured to be capable of separately adjusting the positions of the left and right display units 103 (of the display main body 101) in the front-back direction. As described above, each of users with different head shapes is able to adjust the positions of the left and right display units 103 (of the display main body 101) in the up-down direction and the front-back direction by using the up-down position adjustment mechanism 501 and the front-back position adjustment mechanism 502 and hold them.

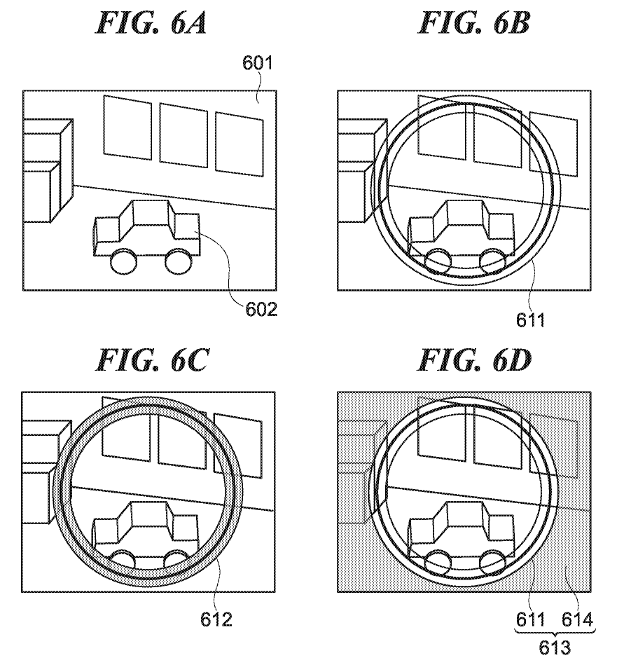

FIGS. 6A, 6B, 6C, and 6D are views that illustrate MR images displayed on the display panel 301, which is one of the internal components of the display unit 103 of the display main body 101. FIG. 6A is a view that illustrates an MR image obtained by compositing a CG image 602 with a background image 601, which is generated based on the real space image obtained by the background image cameras 102A. FIG. 6B is a view that illustrates an image obtained by compositing an indicator image 611 with the MR image shown in FIG. 6A. The indicator image 611 is composited at an edge of an area in which the user is able to theoretically view the MR image through the display unit 103 in the case where the positions of the left and right display units 103 respectively become positions correct for both eyes of the user (hereinafter, referred to as “a theoretical viewing area”).

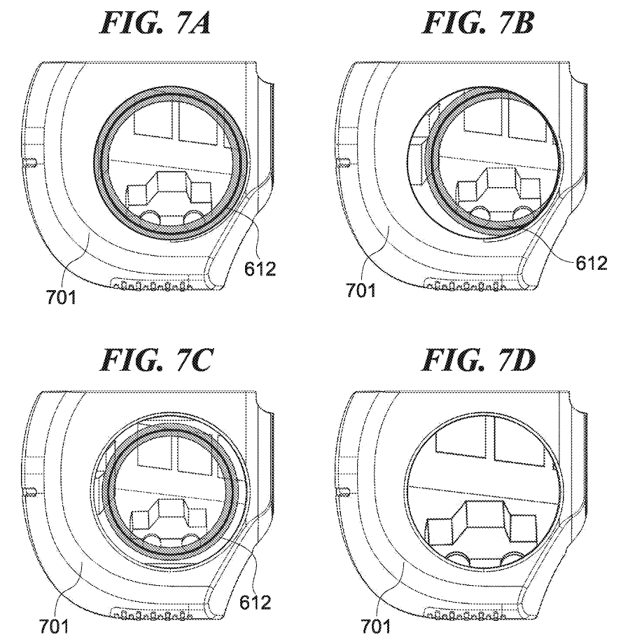

In FIG. 6B, the indicator image 611 is a circular frame line (a predetermined figure) configured with (made up of) three concentric lines. Among the three concentric lines of the indicator image 611, the central line indicates an edge of the theoretical viewing area in the case where component tolerance of the lens, the panel, or the like (hereinafter, abbreviated as “component tolerance”) is at its median value. The outer line indicates an edge of the theoretical viewing area in the case where the component tolerance is at its maximum value. The inner line indicates an edge of the theoretical viewing area in the case where the component tolerance is at its minimum value. In this way, the indicator image 611 corresponds to the component tolerance by using a plurality of concentric lines. The user adjusts the positions of the left and right display units 103 and the position of the display main body 101 so that any one line of the three concentric lines of the indicator image 611 aligns with an inner periphery of a hood member 701 (see FIGS. 7A, 7B, 7C, and 7D) of the display main body 101, which will be described below. In this way, the user is able to view the MR image on the display unit 103 in an appropriate visual recognition state (that is, a state where there is no blurring, misaligned-in-size, or distortion) by adjusting the positions of the left and right display units 103 to the positions correct for both eyes of the user.

It should be noted that instead of the indicator image 611, for example, as shown in FIG. 6C, an indicator image 612 may be composited with the MR image. The indicator image 612 is obtained by coloring an area surrounded by the concentric outer line and the concentric inner line of the indicator image 611. In addition, instead of the indicator image 611, for example, as shown in FIG. 6D, an indicator image 613 may be composited with the MR image. The indicator image 613, which includes the three concentric lines of the indicator image 611, is obtained by coloring an area 614 located outside the concentric outer line of the indicator image 611. These colorings make it easier for the user to recognize the three concentric lines indicating the edges of the theoretical viewing area.

It should be noted that the type of a color to be used to color the indicator image 612 and the indicator image 613 is not limited, but it is desirable that the color be highly visible. In addition, the indicator image (the indicator image 611, the indicator image 612, or the indicator image 613) is capable of being switched between display and non-display. The information processing apparatus 110 hides the indicator image (the indicator image 611, the indicator image 612, or the indicator image 613) in response to an input from the operation unit 207 by the user who has finished the position adjustment of the display unit 103 and the display main body 101. As a result, the information processing apparatus 110 is capable of preventing the user's MR experience after the position adjustment from being hindered by the indicator image (the indicator image 611, the indicator image 612, or the indicator image 613).

FIGS. 7A, 7B, 7C, and 7D are views that illustrate MR images when the user views the display panel 301 through the display unit 103L of the display main body 101. In the following, the display unit 103L will be described with reference to FIGS. 7A, 7B, 7C, and 7D, but the display unit 103R is also capable of being described in a similar manner. Therefore, the description of the display unit 103R will be omitted. FIG. 7A is a view that illustrates a state in which the inner periphery of the hood member 701 of the display main body 101 aligns with the outer line of the indicator image 612, and the position of the display unit 103L becomes the position correct for the left eye EL of the user, so that the MR image is visible in the appropriate visual recognition state. In other words, in the case where the position of the display unit 103L becomes the position correct for the left eye EL of the user, when the user views the display panel 301 through the display unit 103L, a peripheral area of the display panel 301 is blocked by the hood member 701. In this way, the theoretical viewing area is defined by the hood member 701.

FIG. 7B is a view that illustrates a state in which the upper right portion of the indicator image 612 is not visible. In this case, the left eye EL of the user is positioned above and to the right of the display unit 103L. Therefore, the user is able to adjust the position of the display unit 103L to the position correct for the left eye EL of the user, by moving the display main body 101 upward and moving the display unit 103L to the right.

FIG. 7C is a view that illustrates a state in which the outside of the indicator image 612 is visible. In this case, the left eye EL of the user is positioned close to the display unit 103L. Therefore, the user is able to adjust the position of the display unit 103L to the position correct for the left eye EL of the user, by moving the display main body 101 forward (that is, away from the user).

FIG. 7D is a view that illustrates a state in which the indicator image 612 is not visible. In this case, the left eye EL of the user is positioned far away from the display unit 103L. Therefore, the user is able to adjust the position of the display unit 103L to the position correct for the left eye EL of the user, by moving the display main body 101 backward (that is, toward the user). The indicator image 612 has been described with reference to FIGS. 7A, 7B, 7C, and 7D, but the indicator image 611 and the indicator image 613 are also capable of being similarly described. Therefore, the description of the indicator image 611 and the indicator image 613 will be omitted.

It should be noted that depending on the optical system of the display unit 103, even if the positions of the left and right display units 103 respectively become positions correct for both eyes of the user, in a range inside the inner periphery of the hood member 701, an area where the image on the display panel 301 is not capable of being viewed correctly may appear optically. This is the case where, when the user directs both eyes toward the edge of the theoretical viewing area, a range in which the image on the display panel 301 is capable of being viewed correctly becomes optically narrower than the theoretical viewing area. In such a case, the indicator image (the indicator image 611, the indicator image 612, or the indicator image 613) is composited with the image on the display panel 301 so as to indicate an edge of an area where the user is able to optically and correctly view the image on the display panel 301. In this way, the area where the user is able to optically and correctly view the image on the display panel 301 is treated as the theoretical viewing area.

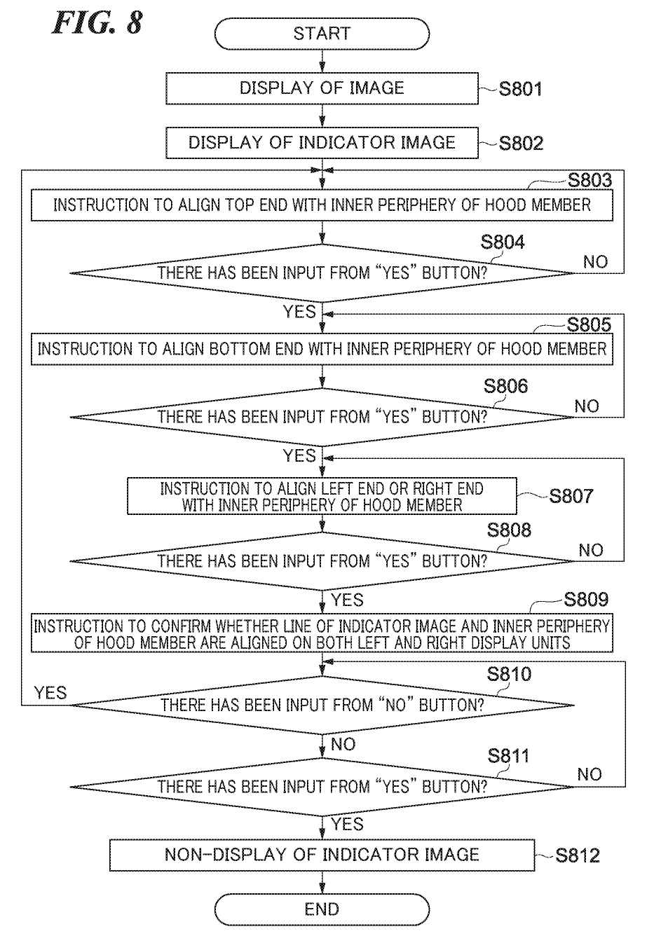

FIG. 8 is a flowchart that illustrates the operation of the information processing apparatus 110 when controlling the display and non-display of the indicator image (the indicator image 611, the indicator image 612, or the indicator image 613). The flowchart shown in FIG. 8 (a control method for the information processing apparatus) is realized by the CPU 201 (a computer) loading a program stored in the ROM 203 or the storage 205 into the RAM 204 and executing the program. It should be noted that when the attitude detection cameras 102B detect that the user is wearing the HMD 100, the CPU 201 starts the flowchart shown in FIG. 8.

As shown in FIG. 8, in a step S801, the CPU 201 performs the display of the image. As a result, the MR image is displayed on the display panel 301. In a step S802, the CPU 201 (a display processing unit serving as a display means) performs the display of the indicator image (a display step). As a result, the indicator image (the indicator image 611, the indicator image 612, or the indicator image 613) is displayed on the display panel 301 in a state where it has been composited with the MR image. In this case, when the indicator image 612 or the indicator image 613 is displayed on the left and right display panels 301, the color (a first color) (a second color) to be used to color the indicator image 612 or the indicator image 613 may be different between the left and right display units 103. Specifically, for example, on one of the left and right display units 103, the indicator image 612 or the indicator image 613 is colored red, and on the other of the left and right display units 103, the indicator image 612 or the indicator image 613 is colored blue. In addition, similarly, the display color of the three concentric lines of the indicator image 611, the indicator image 612, or the indicator image 613 may be different between the left and right display units 103.

It should be noted that in the following, the case where the indicator image 611 is displayed on the display panel 301 will be described, but the case where the indicator image 612 is displayed on the display panel 301 and the case where the indicator image 613 is displayed on the display panel 301 are also capable of being similarly described. Therefore, the description of the case where the indicator image 612 is displayed on the display panel 301 and the case where the indicator image 613 is displayed on the display panel 301 will be omitted.

In a step S803, the CPU 201 (an instructing unit serving as an instructing means) issues, to the user via the audio output unit 206, an instruction to align the top end of any one of the three concentric lines of the indicator image 611 with the inner periphery of the hood member 701 of the display main body 101. Upon receiving this instruction, the user adjusts the position of the display main body 101 in the up-down direction, thereby adjusting the position of the display unit 103 in the up-down direction. As a result, the user aligns the top end of any one of the three concentric lines of the indicator image 611 with the inner periphery of the hood member 701 of the display main body 101 on at least one of the left and right display units 103. Thereafter, the user presses the “YES” button of the operation unit 207. In addition, also in the case where the aligning the top end of any one of the three concentric lines of the indicator image 611 with the inner periphery of the hood member 701 of the display main body 101 in the step S803 has already been established, the user presses the “YES” button of the operation unit 207. It should be noted that in the following description, the line among the three concentric lines of the indicator image 611 that has been the target of the aligning in the step S803 will be referred to as “a line of the indicator image 611”.

In a step S804, the CPU 201 determines whether or not there has been an input from the “YES” button of the operation unit 207. In the case where the CPU 201 determines that there has been no input from the “YES” button of the operation unit 207, the processing returns to the step S803. On the other hand, in the case where the CPU 201 determines that there has been an input from the “YES” button of the operation unit 207, the processing proceeds to a step S805.

In the step S805, the CPU 201 (the instructing means) issues, to the user via the audio output unit 206, an instruction to align the bottom end of the line of the indicator image 611 with the inner periphery of the hood member 701 of the display main body 101. Upon receiving this instruction, the user adjusts the position of the display main body 101 in the front-back direction, thereby adjusting the position of the display unit 103 in the front-back direction. As a result, the user aligns the bottom end of the line of the indicator image 611 with the inner periphery of the hood member 701 of the display main body 101 on at least one of the left and right display units 103. This is because in the case where the top end of the line of the indicator image 611 is aligned with the inner periphery of the hood member 701 of the display main body 101 but the bottom end of the line of the indicator image 611 is not aligned with the inner periphery of the hood member 701 of the display main body 101, a positional shift of the display unit 103 occurs in the front-back direction. Thereafter, the user presses the “YES” button of the operation unit 207. In addition, also in the case where the aligning the bottom end of the line of the indicator image 611 with the inner periphery of the hood member 701 of the display main body 101 in the step S805 has already been established, the user presses the “YES” button of the operation unit 207.

In a step S806, the CPU 201 determines whether or not there has been an input from the “YES” button of the operation unit 207. In the case where the CPU 201 determines that there has been no input from the “YES” button of the operation unit 207, the processing returns to the step S805. On the other hand, in the case where the CPU 201 determines that there has been an input from the “YES” button of the operation unit 207, the processing proceeds to a step S807.

In the step S807, the CPU 201 (the instructing means) issues, to the user via the audio output unit 206, an instruction to align the left end or the right end of the line of the indicator image 611 with the inner periphery of the hood member 701 of the display main body 101. Upon receiving this instruction, the user adjusts the position of at least one of the left and right display units 103 in the left-right direction. As a result, the user aligns the left end or the right end of the line of the indicator image 611 with the inner periphery of the hood member 701 of the display main body 101 on at least one of the left and right display units 103. Thereafter, the user presses the “YES” button of the operation unit 207. In addition, also in the case where the aligning the left end or the right end of the line of the indicator image 611 with the inner periphery of the hood member 701 of the display main body 101 in the step S807 has already been established, the user presses the “YES” button of the operation unit 207.

In a step S808, the CPU 201 determines whether or not there has been an input from the “YES” button of the operation unit 207. In the case where the CPU 201 determines that there has been no input from the “YES” button of the operation unit 207, the processing returns to the step S807. On the other hand, in the case where the CPU 201 determines that there has been an input from the “YES” button of the operation unit 207, the processing proceeds to a step S809.

In the step S809, the CPU 201 issues, to the user via the audio output unit 206, an instruction to confirm whether or not the line of the indicator image 611 is aligned with the inner periphery of the hood member 701 of the display main body 101 on both the left and right display units 103. Upon receiving this instruction, the user confirms whether or not the line of the indicator image 611 is aligned with the inner periphery of the hood member 701 of the display main body 101 on both the left and right display units 103. At this time, if the user confirms that the line of the indicator image 611 is not aligned with the inner periphery of the hood member 701 of the display main body 101 on at least one of the left and right display units 103, the user presses the “NO” button of the operation unit 207. On the other hand, if the user confirms that the line of the indicator image 611 is aligned with the inner periphery of the hood member 701 of the display main body 101 on both the left and right display units 103, the user presses the “YES” button of the operation unit 207. It should be noted that in this case, the positions of the left and right display units 103 respectively become the positions correct for both eyes of the user.

In a step S810, the CPU 201 determines whether or not there has been an input from the “NO” button of the operation unit 207. In the case where the CPU 201 determines that there has been an input from the “NO” button of the operation unit 207, the processing returns to the step S803. As a result, the processes of the steps S803 to S810 are repeated until the line of the indicator image 611 is aligned with the inner periphery of the hood member 701 of the display main body 101 on both the left and right display units 103. On the other hand, in the case where the CPU 201 determines that there has been no input from the “NO” button of the operation unit 207, the processing proceeds to a step S811.

In the step S811, the CPU 201 determines whether or not there has been an input from the “YES” button of the operation unit 207. In the case where the CPU 201 determines that there has been no input from the “YES” button of the operation unit 207, the processing returns to the step S810. On the other hand, in the case where the CPU 201 determines that there has been an input from the “YES” button of the operation unit 207, the processing proceeds to a step S812.

In the step S812, the CPU 201 (a non-display processing unit serving as a non-display means) performs the non-display of the indicator image, that is, the CPU 201 hides the indicator image. As a result, the MR image on the display panel 301 becomes in a state where the indicator image 611 has not been composited, in response to an input from the “YES” button by the user. After that, the flowchart shown in FIG. 8 ends. It should be noted that in the flowchart shown in FIG. 8, there has been an execution order of the steps S803 to S804, the steps S805 to S806, and the steps S807 to S808, but the execution order is not limited to the order shown in the flowchart of FIG. 8, and the steps S803 to S804, the steps S805 to S806, and the steps S807 to S808 may be executed in any order.

In addition, the user is able to perform the operation of aligning the line of the indicator image 611 with the inner periphery of the hood member 701 of the display main body 101 (hereinafter, referred to as “an alignment operation”) alternately or in parallel on one and the other of the left and right display units 103, or is able to perform the alignment operation sequentially on one and the other of the left and right display units 103. It should be noted that in the case where the alignment operation is performed alternately or in parallel on one and the other of the left and right display units 103, the processes of the steps S803 to S810 are capable of being performed without being repeated.

In addition, the CPU 201 may first execute the processes of the steps S803 to S808 in a state in which the display panel 301 is lighted on only one of the left and right display units 103, and then execute the processes of the steps S803 to S808 in a state in which the display panel 301 is lighted on only the other of the left and right display units 103. As a result, even if it is difficult for the user to close one eye, the user is able to perform the alignment operation sequentially on one and the other of the left and right display units 103. It should be noted that in this case, the processes of the steps S809 to S811 are capable of being omitted. In addition, the CPU 201 executes the process of the step S812 in a state in which the display panel 301 is lighted on both the left and right display units 103.

As described above, in the first embodiment, the CPU 201 of the information processing apparatus 110 performs the display of the indicator image 611 by compositing the indicator image 611 at the edge of the theoretical viewing area, with respect to the MR image that the user is able to view through the left and right display units 103 of the HMD 100. Meanwhile, the user adjusts the position of the display main body 101 and/or separately adjusts the positions of the left and right display units 103 to align the indicator image 611 with the inner periphery of the hood member 701 of the display main body 101. In this way, the user adjusts the positions of the left and right display units 103 to the positions correct for both eyes of the user. As a result, the user is able to view the MR image in the appropriate visual recognition state through the left and right display units 103 respectively held in front of both eyes. This also applies to the indicator image 612 and the indicator image 613.

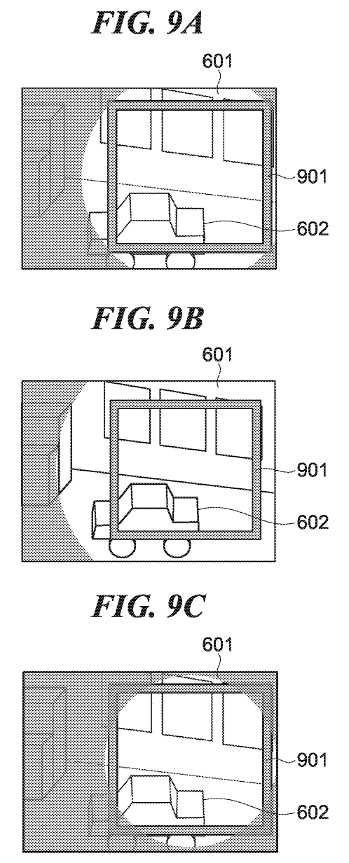

Hereinafter, a second embodiment of the present disclosure will be described with reference to FIGS. 9A, 9B, and 9C. In the second embodiment, differences from the first embodiment will be described. In addition, in the second embodiment, the display unit 103L will be described, but the display unit 103R is also capable of being similarly described. Therefore, in the second embodiment, the description of the display unit 103R will be omitted. FIGS. 9A, 9B, and 9C are views that illustrate how the display panel 301 appears when the user views the display panel 301 through the display unit 103L of the display main body 101. In FIGS. 9A, 9B, and 9C, in an MR image displayed on the display panel 301, a range inside the inner periphery of the hood member 701 of the display main body 101 is shown with a white background color.

In addition, in FIG. 9A, the area shown with the white background color also indicates the theoretical viewing area of the MR image on the display panel 301. Therefore, the center (of the theoretical viewing area) of the MR image on the display panel 301 viewed by the user through the display unit 103L is shifted to the right. On the other hand, although not shown, the MR image on the display panel 301 viewed by the user through the display unit 103R is similar to the MR image on the display panel 301 viewed by the user through the display unit 103L, except that the center (of the theoretical viewing area) of the MR image on the display panel 301 viewed by the user through the display unit 103R is shifted to the left.

In this way, the MR image displayed on either the left display panel 301 or the right display panel 301 is intentionally shifted toward a gap between the left and right display panels 301, thereby creating an overlap on the side of the gap between the left and right display panels 301. This gives the MR image on the display panel 301 viewed by the user through the display unit 103 of the display main body 101 a three-dimensional appearance. In addition, although the MR images on the left and right display panels 301 do not overlap on the side opposite to the side of the gap between the left and right display panels 301, the display area is expanded. This allows the MR image on the display panel 301 viewed by the user through the display unit 103 of the display main body 101 to obtain a wider display angle of view than when the user is viewing with both eyes.

In addition, in order to accommodate a wider range of head shapes of users, the HMD 100 may have a portion of the lens cut out to prevent the user's nose or forehead from touching the lens. In this case, as in the MR image on the display panel 301 shown in FIG. 9A, there may be an area in the circular theoretical viewing area that is invisible to the user near the side of the gap between the left and right display panels 301.

Unlike the indicator image 611, the indicator image 612, or the indicator image 613 that is the circular frame line made up of the three concentric lines, an indicator image 901 shown in each of FIGS. 9A, 9B, and 9C is a rectangular frame line (a predetermined figure) configured with (made up of) thick lines. The indicator image 901 is composited with the MR image so that each of the four corners of the indicator image 901 is aligned with a part of the edge of the theoretical viewing area. In other words, the indicator image 901 indicates a part of the edge of the theoretical viewing area with its four corners. In addition, the rectangular shape of the indicator image 901 allows the indicator image 901 to be used even in the case where the optical systems of the left and right display units 103 have non-circular lenses. FIG. 9A is a view that illustrates a state in which the position of the display unit 103L becomes the position correct for the left eye EL of the user so that the MR image on the display panel 301 viewed by the user through the display unit 103L is visible in the appropriate visual recognition state. In this case, each of the four corners of the indicator image 901 is aligned with a part of the inner periphery of the hood member 701 of the display main body 101.

FIG. 9B is a view that illustrates a state in which the outside of the indicator image 901 is visible. In this case, the left eye EL of the user is positioned close to the display unit 103L. Therefore, the user is able to adjust the position of the display unit 103L to the position correct for the left eye EL of the user, by moving the display main body 101 forward (that is, away from the user).

FIG. 9C is a view that illustrates a state in which the four corners of the indicator image 901 are not visible and only straight line portions of the indicator image 901 are visible. In this case, the left eye EL of the user is positioned far away from the display unit 103L. Therefore, the user is able to adjust the position of the display unit 103L to the position correct for the left eye EL of the user, by moving the display main body 101 backward (that is, toward the user).

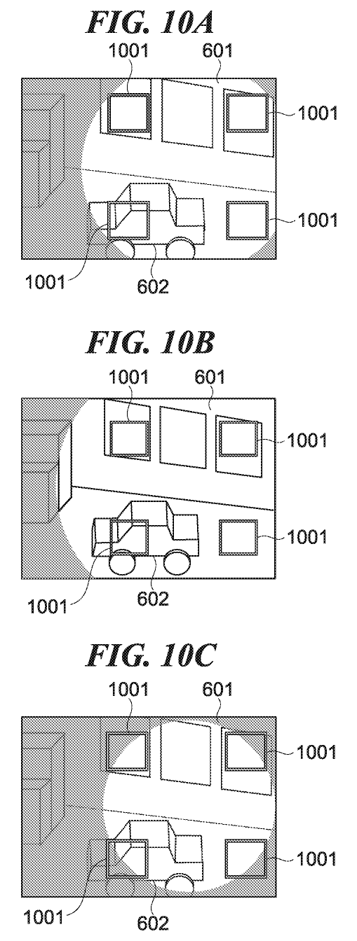

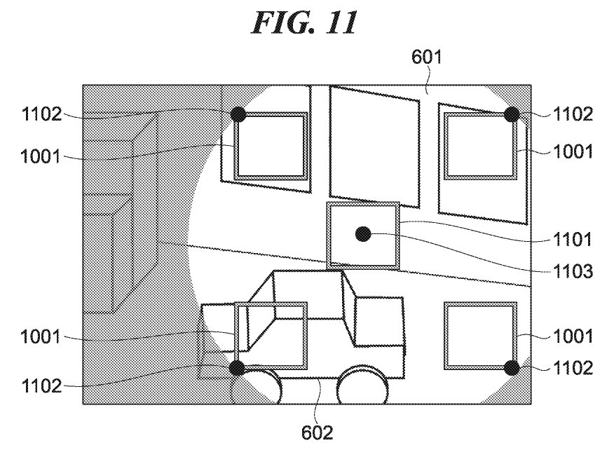

Hereinafter, a third embodiment of the present disclosure will be described with reference to FIGS. 10A to 11. In the third embodiment, differences from the second embodiment will be described. In addition, in the third embodiment, the display unit 103L will be described, but the display unit 103R is also capable of being similarly described. Therefore, in the third embodiment, the description of the display unit 103R will be omitted. FIGS. 10A, 10B, and 10C are views that illustrate how the display panel 301 appears when the user views the display panel 301 through the display unit 103L of the display main body 101. Similar to FIGS. 9A, 9B, and 9C, in 10A, 10B, and 10C, in an MR image displayed on the display panel 301, a range inside the inner periphery of the hood member 701 of the display main body 101 is shown with a white background color. In addition, in FIG. 10A, the area shown with the white background color also indicates the theoretical viewing area of the MR image on the display panel 301.

Similar to the indicator image 901, each of four indicator images 1001 shown in each of FIGS. 10A, 10B, and 10C, is a rectangular frame line (a predetermined figure) configured with (made up of) thick lines. Furthermore, the four indicator images 1001 are respectively located at positions corresponding to the four corners of the indicator image 901. In other words, in the third embodiment, the four indicator images 1001 constitute (form) one indicator image that indicates a part of the edge of the theoretical viewing area. It should be noted that two, three, five or more indicator images 1001 (a plurality of indicator images 1001) may constitute one indicator image that indicates a part of the edge of the theoretical viewing area. In this way, a plurality of indicator images may constitute one indicator image that indicates the edge of the theoretical viewing area, or a part of the edge of the theoretical viewing area.

FIG. 10A is a view that illustrates a state in which the position of the display unit 103L becomes the position correct for the left eye EL of the user so that the MR image on the display panel 301 viewed by the user through the display unit 103L is visible in the appropriate visual recognition state. In this case, of the four corners of each indicator image 1001, the corner farthest from the center of the circular theoretical viewing area is aligned with a part of the inner periphery of the hood member 701 of the display main body 101.

FIG. 10B is a view that illustrates a state in which the outside of each indicator image 1001 is visible. In this case, the left eye EL of the user is positioned close to the display unit 103L. Therefore, the user is able to adjust the position of the display unit 103L to the position correct for the left eye EL of the user, by moving the display main body 101 forward (that is, away from the user).

FIG. 10C is a view that illustrates a state in which all the four corners of each indicator image 1001 are not visible. In this case, the left eye EL of the user is positioned far away from the display unit 103L. Therefore, the user is able to adjust the position of the display unit 103L to the position correct for the left eye EL of the user, by moving the display main body 101 backward (that is, toward the user).

FIG. 11 is a view that illustrates how the display panel 301 appears when the user views the display panel 301 through the display unit 103L of the display main body 101. Similar to FIGS. 9A, 9B, and 9C, in 11, in an MR image displayed on the display panel 301, a range inside the inner periphery of the hood member 701 of the display main body 101 is shown with a white background color. In addition, in FIG. 11, the area shown with the white background color also indicates the theoretical viewing area of the MR image on the display panel 301.

As shown in FIG. 11, in addition to four indicator images 1001 (hereinafter, also referred to as “indicator images located at the four corners 1001”, or simply referred to as “each four-corner indicator image 1001”), the MR image on the display panel 301 has a rectangular frame line that is located at the center of the four indicator images 1001 and is similar to the rectangular frame line of the indicator image 1001 (hereinafter, referred to as “a central rectangle 1101”). In addition, each four-corner indicator image 1001 has an indicator image 1102 configured by (made up of) a dot shape at the corner farthest from the center of the circular theoretical viewing area. Furthermore, the central rectangle 1101 has a dot shape 1103, which is similar to the indicator image 1102, in its center.

In this case, the user first grasps (understands) each four-corner indicator image 1001 as a rough target to be aligned with the inner periphery of the hood member 701, and then aligns the indicator image 1102, which is configured by the dot shape located in each four-corner indicator image 1001, with the inner periphery of the hood member 701. As a result, the position correct for the left eye EL of the user becomes clearer, making it easier for the user to adjust the position of the display unit 103L to the position correct for the left eye EL of the user. Furthermore, the user is able to easily adjust the position of the display unit 103L and the position of the display main body 101 by trying to align the dot shape 1103 in the center of the central rectangle 1101 with the center of the range inside the inner periphery of the hood member 701. In this way, one indicator image may be configured by combining a plurality of types of figures(in FIG. 11, the plurality of types of figures is the rectangle of the indicator image 1001, the dot shape of the indicator image 1102, the central rectangle 1101, and the dot shape 1103).

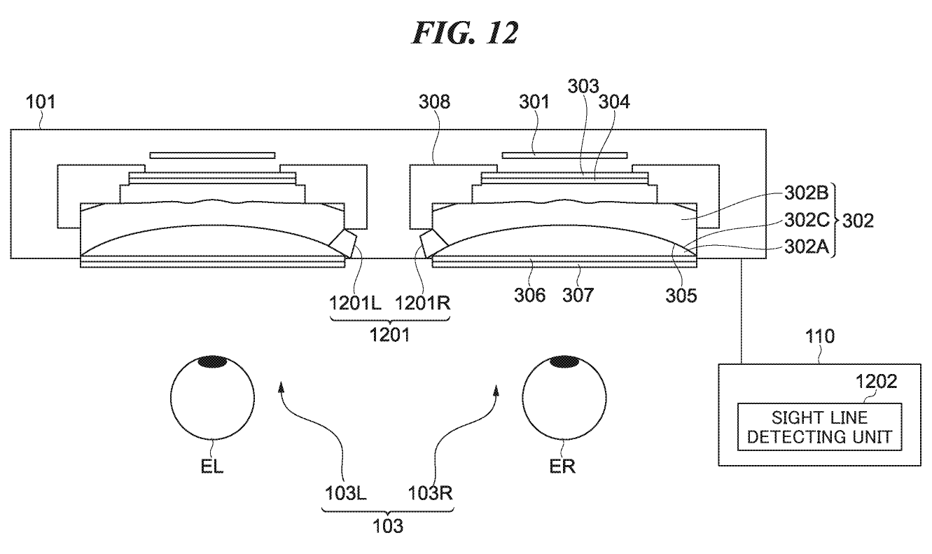

Hereinafter, a fourth embodiment of the present disclosure will be described with reference to FIG. 12. In the fourth embodiment, differences from the first embodiment will be described. FIG. 12 is a view that illustrates a configuration for sight line detection between the display main body 101 and the information processing apparatus 110. FIG. 12 shows the functional configuration of the information processing apparatus 110, and a cross section of the hardware configuration of the display unit 103 of the display main body 101. The cross section of the display unit 103 shown in FIG. 12 is a cross section in which a sight line detection camera 1201 is added to the cross section of the display unit 103 shown in FIG. 3.

The sight line detection camera 1201 includes a sight line detection camera 1201R and a sight line detection camera 1201L. The sight line detection camera 1201R is used to capture an image of the right eye ER of the user wearing the HMD 100. The sight line detection camera 1201L is used to capture an image of the left eye EL of the user wearing the HMD 100. As a result, the sight line detection camera 1201 becomes able to detect the positions of both eyes of the user relative to the left and right display units 103. The information processing apparatus 110 includes a sight line detecting unit 1202. The CPU 201 (a sight line detection processing unit serving as a sight line detecting means) obtains sight line information, which indicates where a sight line of the user is facing, from the images captured by the sight line detection camera 1201 (the image of the right eye ER of the user wearing the HMD 100 captured by the sight line detection camera 1201R and the image of the left eye EL of the user wearing the HMD 100 captured by the sight line detection camera 1201L) by using the sight line detecting unit 1202.

In the fourth embodiment, when the attitude detection cameras 102B detect that the user is wearing the HMD 100, the CPU 201 of the information processing apparatus 110 issues, to the user via the audio output unit 206, an instruction to move both eyes widely up and down and left and right. Upon receiving this instruction, the user moves the right eye ER and the left eye EL widely up and down and left and right. At this time, as a calibration of the sight line detecting unit 1202, the CPU 201 is capable of measuring the deviation between the eyeball position and the display unit 103 by measuring the degree of reflection of infrared light (not shown). Furthermore, when the audio output unit 206 has issued, to the user, the instruction to move both eyes widely up and down and left and right, the CPU 201 starts the flowchart shown in FIG. 8. As a result, at the same time as the calibration of the sight line detecting unit 1202 is performed, the user is able to adjust the position of the display unit 103 and the position of the display main body 101 to adjust the positions of the left and right display units 103 to the positions correct for both eyes of the user.

It should be noted that during the execution of the flowchart shown in FIG. 8, the sight line of the user who is performing the alignment operation is directed toward the top end, the bottom end, the left end, or the right end of the line of the indicator image 611. Therefore, when the user is performing the alignment operation in accordance with the instruction that has been issued, for example, in the step S803, the CPU 201 (the sight line detecting means) may perform the calibration of the sight line detecting unit 1202.

In addition, the CPU 201 may determine whether or not the positions of the left and right display units 103 respectively become the positions correct for both eyes of the user, based on the positions of both eyes of the user relative to the display unit 103 that have been detected by the sight line detection camera 1201. Furthermore, in this case, when the CPU 201 determines that the positions of the left and right display units 103 respectively become the positions correct for both eyes of the user, the CPU 201 may perform the non-display of the indicator image of the step S812 (that is, may hide the indicator image).

Although the embodiments of the present disclosure have been described above, the present disclosure is not limited to the above-described embodiments, and various modifications and changes are possible within the scope of the gist of the present disclosure. For example, in the information processing apparatus 110, the person operating the operation unit 207 may be a person on the XR provider side, rather than a user wearing the HMD 100. In this case, the person on the XR provider side operates the operation unit 207 in response to a voice, a sign, or the like from the user wearing the HMD 100.

In addition, in the flowchart shown in FIG. 8, the processes of the steps S803 to S810 may be omitted. In this case, the user adjusts the position of the display unit 103 and the position of the display main body 101 to adjust the positions of the left and right display units 103 to the positions correct for both eyes of the user, by his/her own will or in accordance with instructions from the person on the XR provider side. Furthermore, in this case, the processes of the steps S801, S802, and S812 may be performed in response to an operation performed by the user or the person on the XR provider side.

The present disclosure can also be realized by supplying a program that realizes one or more functions of each of the above embodiments to a system or an apparatus via a network or storage medium, and having one or more processors of a computer in the system or the apparatus read and execute the program. In addition, the present disclosure can also be realized by a dedicated processor (e.g., circuitry such as an ASIC or FPGA) that implements one or more functions. Furthermore, the present disclosure can also be realized by using a combination of a general-purpose processor and a dedicated processor. It should be noted that the term “processor” refers to a processor in a broad sense, including a general-purpose processor and a dedicated processor. In addition, the operations of a processor may not only be performed by a single processor, but may also be performed by a plurality of processors located in physically separate locations in cooperation with each other.

According to the present disclosure, the user is able to view the images in the appropriate visual recognition state through the left and right display units respectively held in front of both eyes of the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046544, filed March 21, 2025, which is hereby incorporated by reference herein in its entirety.

What is claimed is:

1. An information processing apparatus comprising one or more processors and memory configured to:
execute a display processing that performs a display of an indicator image in an image that a user is able to view through left and right display units whose positions are capable of being adjusted separately at least in a front-back direction and a left-right direction when respectively held in front of both eyes of the user, and
wherein in the display processing, the display of the indicator image is performed as a display indicating an edge of a theoretical viewing area in which the user is able to theoretically view the image through the left and right display units in a case where the positions of the left and right display units respectively become positions correct for both eyes of the user.

2. The information processing apparatus according to claim 1, wherein
in the display processing, the display of the indicator image is performed as a display indicating at least a part of the edge of the theoretical viewing area.

3. The information processing apparatus according to claim 1, wherein
the theoretical viewing area is defined by a hood member that has been attached to each of the left and right display units.

4. The information processing apparatus according to claim 3, wherein
the one or more processors and memory is further configured to execute an instruction processing that issues, to the user, an instruction to align an inner periphery of the hood member with the indicator image by adjusting the position of each of the left and right display units.

5. The information processing apparatus according to claim 4, wherein
the one or more processors and memory is further configured to execute a sight line detection processing that detects a sight line of the user, and
in the sight line detection processing, a calibration is performed when the instruction is issued to the user by the instruction processing.

6. The information processing apparatus according to claim 1, wherein
in the display processing, the display of the indicator image is performed by using a predetermined figure.

7. The information processing apparatus according to claim 6, wherein
the predetermined figure is a circular frame line.

8. The information processing apparatus according to claim 6, wherein
the predetermined figure is a rectangular frame line.

9. The information processing apparatus according to claim 6, wherein
in the display processing, the display of the indicator image is performed by using a plurality of the predetermined figures.

10. The information processing apparatus according to claim 1, wherein
in the display processing, the display of the indicator image is performed by combining a plurality of types of figures.

11. The information processing apparatus according to claim 1, wherein
in the display processing, the display of the indicator image is performed by coloring.

12. The information processing apparatus according to claim 11, wherein
in the display processing, the user performs the display of the indicator image on one of the left and right display units by coloring with a first color, and the user performs the display of the indicator image on the other of the left and right display units by coloring with a second color different from the first color.

13. The information processing apparatus according to claim 1, wherein
in the display processing, a range that is optically visible when both eyes of the user are directed toward the edge of the theoretical viewing area through the left and right display units is treated as the theoretical viewing area.

14. The information processing apparatus according to claim 1, wherein
the one or more processors and memory is further configured to execute a non-display processing that hides the indicator image.

15. The information processing apparatus according to claim 14, wherein
in the non-display processing, the indicator image is hidden in response to an input from the user.

16. The information processing apparatus according to claim 1, wherein
the image that the user views through the left and right display units is an XR image.

17. A head mounted display comprising:
the information processing apparatus according to claim 1;
the left and right display units; and
a holding portion for holding the left and right display units on a user's head or in a user's hand.

18. A control method for an information processing apparatus, the control method comprising:
a display step of performing a display of an indicator image in an image that a user is able to view through left and right display units whose positions are capable of being adjusted separately at least in a front-back direction and a left-right direction when respectively held in front of both eyes of the user, and
wherein in the display step, the display of the indicator image is performed as a display indicating an edge of a theoretical viewing area in which the user is able to theoretically view the image through the left and right display units in a case where the positions of the left and right display units respectively become positions correct for both eyes of the user.

19. A non-transitory computer-readable storage medium storing a program for causing a computer to execute a control method for an information processing apparatus, the control method comprising:
a display step of performing a display of an indicator image in an image that a user is able to view through left and right display units whose positions are capable of being adjusted separately at least in a front-back direction and a left-right direction when respectively held in front of both eyes of the user, and
wherein in the display step, the display of the indicator image is performed as a display indicating an edge of a theoretical viewing area in which the user is able to theoretically view the image through the left and right display units in a case where the positions of the left and right display units respectively become positions correct for both eyes of the user.
